(19) United States
(12) Patent Application Publication
(10) Pub. No.: US 2009/0132237 A1
(43) Pub. Date: May 21, 2009

(54) Orthogonal classification of words in multichannel speech recognizers

(75) Inventor: Yakov Gugenheim, Rehovot (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: L N T S - LINGUISTECH SOLUTION LTD

(21) Appl. No.: 11/984,496

(22) Filed: Nov. 19, 2007

(51) Int. Cl. G06F 17/21

(52) U.S. Cl. 704/10

(57) ABSTRACT

A computerized method for distribution among a multiple dictionaries of a target vocabulary. The vocabulary includes words for use in a speech recognition application installed in a computer system. Each word of the target vocabulary is found in only one of the dictionaries. The words are first categorized based on phonetic length, and distributed into multiple groups each of equal phonetic length. The first groups are secondly categorized based on combinations of vowel sounds. The words of the first groups are placed into second groups accordingly based on having identical vowel sounds. The second groups are thirdly categorized into third groups based on the consonants of the words of the second groups and placement of the consonants relative to the vowel sounds. The words within each of the third groups are compared in pairs for phonetic distance and the words of minimal pairwise phonetic distance between them are placed in fourth groups. The words of each of the fourth groups are distributed into the multiple dictionaries, preferably with no more than one member per fourth group distributed into each of the dictionaries. The multiple dictionaries are preferably mutually orthogonal, that is each of the dictionaries includes words of maximal phonetic distance from each other.

### APPENDIX

A listing of an orthogonal classification of a vocabulary into multiple dictionaries generated according to an embodiment of the present invention is attached to the present application as an Appendix.

### FIELD AND BACKGROUND OF THE INVENTION

The present invention relates to speech recognition and, more particularly, to the conversion of an audio speech signal to readable text data. Specifically, the present invention includes a method which improves speech recognition performance by distributing a large vocabulary of words into multiple dictionaries prior to parallel speech recognition processing using the multiple dictionaries.

In speech recognition systems, a speech recognition engine typically incorporated into a digital signal processor (DSP), inputs a digitized speech signal, and processes the speech signal by comparing its output to a vocabulary found in a dictionary. Upon selecting the word which most closely matches a portion of the input speech signal, the speech recognition engine typically calculates a Confidence Level (CL) for the selected word match. Reference is now made to FIG. 1 which illustrates representative behavior of Confidence Level for matching a single word, as a function of the number of words in the dictionary used in the processing. The confidence level (CL) is over 84% for less than ten words in the dictionary. When one hundred words are available in the dictionary, the confidence level (CL) is 67% and for 200 or more words in the dictionary, the CL is reduced to 63%. Furthermore, as the number of words in the dictionary increases, the CL calculated becomes unreliable to the extent that the true word recognition may have a lower CL than a false word recognition. For a large number, e.g. 200 or more words in the dictionary, the confidence level may vary dependent on the other words in the dictionary. As the dictionary increases in size, so does the sensitivity to different speakers, to speaker accent and/or to spoken variations by the same speaker.

There is thus a need for, and it would be highly advantageous to have a method of improving speech recognition performance by distributing a large vocabulary of words into multiple dictionaries prior to parallel speech recognition processing using the multiple dictionaries and in such a way achieve higher confidence levels for a large vocabulary than is found for a single processing using the entire vocabulary.

In human language, the term “phoneme” as used herein is the smallest unit of speech that distinguishes meaning or the basic unit of sound in a given language that distinguishes one word from another. An example of a phoneme would be the ‘t’ found in words like “tip”, “stand”, “writer”, and “cat”.

A “phonemic transcription” of a word is a representation of the word comprising a series of phonemes. For example, the initial sound in “cat” and “kick” may be represented by the phonemic symbol ‘k’ while the one in “circus” may be represented by the symbol ‘s’. Further, ‘ ’ will be used to distinguish a symbol as a phonemic symbol, unless otherwise indicated. In contrast to a phonemic transcription of a word, the term “orthographic transcription” of the word refers to the typical spelling of the word.

The term “phonetic distance” as used herein referring to two words Word1 and Word2 is a relative measure of how difficultly the two words are confused by a speech recognition engine. For a large “phonetic distance” there is a small probability of recognizing Word1 when Word2 is input to the speech recognition engine and similarly there is small probability of the recognizing Word2 when Word1 is input. For a small phonetic distance” there is a relatively large probability of recognizing Word1 when Word2 is input to the speech recognition engine and similarly there is relatively large probability of the recognizing Word2 when Word1 is input. The term “Levinstein distance” as used herein is the number of substitutions, insertions or deletions needed to transform one phonemic transcription, e.g. of Word1 into another, e.g. Word2. The “Levinstein distance” is a special case of “phonetic distance”. As will be described, a number of different algorithms may be used individually or in combination, according to different embodiments of the present invention for calculating phonetic distance.

The term “phonetic length” as used herein referring to a single word is a measure of the number of syllables or vowel sounds in the word.

U.S. Pat. No. 6,073,099 discloses a method including phonemically transcribing the first and second words into first and second transcriptions; (2) calculating a Levinstein distance between the first and second transcriptions as the number of edit operations required to transform the first transcription into the second transcription; (3) obtaining a phonemic transformation weight for each edit operation of the Levinstein distance; and (4) summing the weights to generate a value indicating the likelihood of confusion between the first and second words. U.S. Pat. No. 6,073,099 is included herein by reference for all purposes as if entirely set forth herein.

The term “formant” as used herein is a peak in an acoustic frequency spectrum which results from the resonant frequencies of human speech. Vowels are distinguished quantitatively by the formants of the vowel sounds. Most formants are produced by tube and chamber resonance, but a few whistle tones derive from periodic collapse of Venturi effect low-pressure zones. The formant with the lowest frequency is called f1, the second f2, and the third f3. Most often the two first formants, f1 and f2, are enough to disambiguate the vowel. These two formants are primarily determined by the position of the tongue. f1 has a higher frequency when the tongue is lowered, and f2 has a higher frequency when the tongue is forward. Generally, formants move about in a range of approximately 1000 Hz for a male adult, with 1000 Hz per formant. Vowels will almost always have four or more distinguishable formants; sometimes there are more than six. Nasals usually have an additional formant around 2500 Hz.

Plosives (and, to some degree, fricatives) modify the placement of formants in the surrounding vowels. Bilabial sounds (such as ‘b’ and ‘p’ as in “ball” or “sap”) cause a lowering of the formants; velar sounds (‘k’ and ‘g’ in English) almost always show f2 and f3 coming together in a ‘velar pinch’ before the velar and separating from the same ‘pinch’ as the velar is released; alveolar sounds (English ‘t’ and ‘d’) cause less systematic changes in neighboring vowel formants, depending partially on exactly which vowel is present. The time-course of these changes in vowel formant frequencies are referred to as ‘formant transitions’. {from http://en.wikipedia.org/wiki/Formant}

The Speech Assessment Methods Phonetic Alphabet (SAMPA) is a computer-readable phonetic script using 7-bit printable ASCII characters, based on the International Phonetic Alphabet (IPA). Sampa was originally developed in the late 1980s for six European languages by the EEC ESPRIT information technology research and development program. As many symbols as possible have been taken over from the IPA; where this is not possible, other signs that are available are used, e.g. [@] for schwa (IPA [symbol] ), [2] for the vowel sound found in French deux (IPA [ø]), and [9] for the vowel sound found in French neuf (IPA [œ]). {from http://en.wikipedia.org/wiki/SAMPA}

The following table is a list of SAMPA phonemic symbols for the Hebrew language. In the table, the first column includes the phonemic symbols, the second column includes transliterated keywords. The ″ symbol is used to denote the accented symbol. The ‘S’ symbol is similar to in English “sh” as in “Washington”. The ‘X’ sound is the voiceless velar fricative, “ch” as in the German composer Bach. The symbol “?” is the glottal stop. A glottal stop is a speech sound articulated by a momentary, complete closing of the glottis in the back of the throat. The symbol ?\ is the voiced pharyngeal approximant/fricative, a type of consonantal sound, approximant, or occasionally fricative, which means the sound is produced by constricting air flow through a channel at the place of articulation that is not usually narrow enough to cause turbulence. Its place of articulation is pharyngeal which means it is articulated with the root of the tongue against the pharynx. The voiced pharyngeal approximant/fricative is voiced, which means the vocal cords are vibrating during the articulation. It is an oral consonant, which means air is allowed to escape through the mouth rather than from the glottis or the mouth.
{from http://en.wikipedia.org/wiki/Voiced_pharyngeal_fricative}

TABLE 1
from Wells, J. C., 1997. ‘SAMPA computer readable phonetic
alphabet’. In Gibbon, D., Moore, R. and Winski, R. (eds.), 1997.
Handbook of Standards and Resources for Spoken Language
Systems. Berlin and New York: Mouton de Gruyter. Part IV,
section B. (http://www.phon.ucl.ac.uk/home/sampa/hebrew.htm)

| | | | |
|---|---|---|---|
| Symbol | Keyword | English gloss | Orthography |

Consonants

| | | | |
|---|---|---|---|
| Plosives | | | |
| p | pil | elephant | [symbol] |
| b | ″bajit | house | [symbol] |
| t | tik | bag | [symbol] |
| d | ″delet | door | [symbol] |
| k | ″kelev | dog | [symbol] |
| g | ga″mal | camel | [symbol] |
| ? | Sa″?al | asked | [symbol] |
| Fricatives | | | |
| f | fa″lafel | felafel | [symbol] |
| v | ″veRed | rose | [symbol] |
| s | sof | end | [symbol] |
| z | za″maR | singer | [symbol] |
| S | SiR | song | [symbol] |
| X | a″RoX | long | [symbol] |
| h | haR | mountain | [symbol] |
| Affricate | | | |
| ts | tsa″laXat | plate | [symbol] |
| Nasals | | | |
| m | ma″Rak | soup | [symbol] |
| n | na″fal | fell | [symbol] |
| Liquids | | | |
| l | la″van | white | [symbol] |
| R | RoS | head | [symbol] |
| Semivowel | | | |
| j | jad | hand | [symbol] |

Vowels

| | | | |
|---|---|---|---|
| i | tik | bag | [symbol] |
| e | ″even | stone | [symbol] |
| a | a″maR | said | [symbol] |
| o | Sa″lom | peace | [symbol] |
| u | guR | puppy | [symbol] |

Rare, dialectal or marginal phonemes

| | | | |
|---|---|---|---|
| Z | ma″saZ | massage | [symbol] |
| X\ | X\a″tul (Xa″tul) | cat | [symbol] |
| tS | tSips | chips | [symbol] |
| dZ | dZins | jeans | [symbol] |
| ?\ | pa″?\al (pa″?al) | acted | [symbol] |

Stress mark

| | | | |
|---|---|---|---|
| ” | ″beReX | knee | [symbol] |
| | be″ReX | he blessed | [symbol] |

### SUMMARY OF THE INVENTION

The term “orthogonal” is used herein in the context of the present invention, referring to a distribution of a vocabulary between multiple dictionaries or sets of words. The multiple dictionaries are substantially “orthogonal” when each dictionary includes words of maximal phonetic distance from each other. Similarly, when dictionaries are “orthogonal”, the vocabulary words of smallest phonetic distance between them appear in different dictionaries. The term “dictionary” hereinafter refers to one or more of the multiple dictionaries or sets of words after the vocabulary has been distributed between the sets, according to embodiments of the present invention.

The term “channel” refers to speech recognition using one of the dictionaries into which the vocabulary has been distributed orthogonally. Whereas in the prior art, a single vocabulary of, for instance eight hundred words is used with a single speech recognition engine, an embodiment of the present invention includes the division of the vocabulary into eight orthogonal dictionaries each of one hundred words. Speech recognition using the present invention is “channelized” using eight channels with eight parallel speech recognition engines processing the same input audio signal each using a different dictionary.

According to the present invention there is provided a computerized method for distribution among a multiple dictionaries of a target vocabulary. The vocabulary includes words for use in a speech recognition application installed in a computer system. Each word of the target vocabulary is found in only one of the dictionaries. The vocabulary and the dictionaries are stored in memory operatively attached to a computer system. The words are first categorized based on phonetic length, and distributed into multiple groups each of equal phonetic length. The first groups are secondly categorized based on combinations of vowel sounds. The words of the first groups are placed into second groups accordingly based on having identical vowel sounds. The second groups are thirdly categorized into third groups based on the consonants of the words of the second groups and placement of the consonants relative to the vowel sounds. The words within each of the third groups are compared in pairs for phonetic distance and the words of minimal pairwise phonetic distance between them are placed in fourth groups. At this point, there are many fourth groups with just a few words (preferably less than 8) within each of the fourth groups. The words of each of the fourth groups are distributed into the multiple dictionaries, preferably with no more than one member per fourth group distributed into each of the dictionaries. The multiple dictionaries are preferably mutually orthogonal, that is each of the dictionaries includes words of maximal phonetic distance from each other. The pairwise comparison is performed by one or more of the following steps: (i) comparing pairwise formants of the vowel sounds of the words, (ii) comparing an anatomical part most responsible for forming respective sounds; (iii) comparing empirically substitution of the words using a speech recognition engine, and (iv) calculating Levinstein distance between the words. The distribution into dictionaries is performed under the constraint of balancing the respective number of words in the dictionaries. While performing the distribution of the words into the dictionaries, weights are calculated for the words not yet distributed. The weights are a measure of phonetic distance for the words not yet distributed to the words already distributed into the dictionaries and distribution is preferably continued based on the weights.

According to the present invention there is provided, a computerized method for distribution among multiple dictionaries of a target vocabulary including multiple words for use in a speech recognition application installed in a computer system. Each word of the target vocabulary is found in only one of the dictionaries. The vocabulary and the dictionaries are stored in memory attached to a computer system. Phonetic distance between the words are compared in pairs, and are placed into groups of minimal phonetic distance between them. The pairwise comparison is performed using one or more of (i) comparison of formants of the vowel sounds of the words, (ii) comparison of the anatomical part most responsible for forming respective sounds; and (iii) comparison based on empirical results of the likelihood of incorrectly substituting the words using a speech recognition engines. The words of the groups are distributed among into the multiple dictionaries and an audio signal is processed using multiple speech recognition engines, each engine referring to one of the dictionaries. Preferably, only one member of each group is distributed into each dictionary. The multiple dictionaries are preferably mutually orthogonal and each of the dictionaries includes words of maximal phonetic distance from each other. The distribution is performed under the constraint of substantially balancing the respective number of words in the dictionaries.

According to the present invention there is provided a computer readable medium readable by a machine, tangibly embodying a program of instructions executable by the machine to perform a computerized method for distribution among a plurality of dictionaries of a target vocabulary. The target vocabulary includes words for use in a speech recognition application installed in a computer system. Each word of the target vocabulary is found in only one of the dictionaries, the method as disclosed herein.

According to the present invention there is provided a computer readable medium readable by a machine, tangibly storing the multiple dictionaries produced by the methods as disclosed herein.

### BRIEF DESCRIPTION OF THE DRAWINGS

The invention is herein described, by way of example only, with reference to the accompanying drawings, wherein:

FIG. 1 illustrates representative behavior of Confidence Level for matching a single word, as a function of the number of words in the vocabulary used in the speech recognition processing;

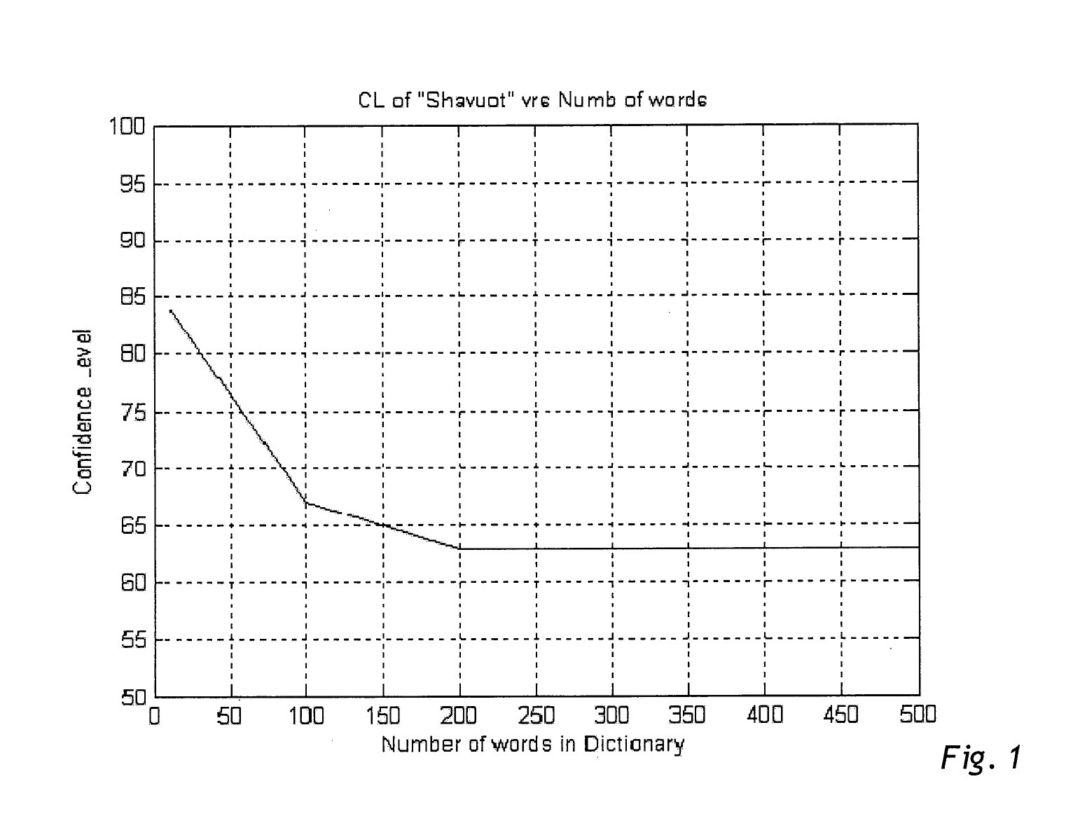

FIG. 2 illustrates a substitution matrix for phonemes in the Hebrew language;

FIG. 3 illustrates schematically a method for distributing a target vocabulary into multiple orthogonal dictionaries; and

FIG. 3A is a flow diagram according to an embodiment of the present invention; and

FIG. 4. illustrates schematically a simplified computer system of the prior art.

### DESCRIPTION OF THE PREFERRED EMBODIMENTS

The present invention is of a method which improves speech recognition performance by distributing a large vocabulary of words into multiple orthogonal dictionaries prior to parallel speech recognition processing using the multiple dictionaries.

The principles and operation of a method of distributing a large vocabulary of words into multiple orthogonal dictionaries prior to parallel speech recognition processing using the multiple dictionaries, according to the present invention, may be better understood with reference to the drawings and the accompanying description.

It should be noted, that although the discussion herein relates to distributing a large vocabulary into multiple orthogonal dictionaries in the Hebrew language, the present invention may, by non-limiting example, alternatively be configured by applying the teachings of the present invention to other languages as well.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The embodiments of the present invention may comprise a general-purpose or special-purpose computer system including various computer hardware components, which are discussed in greater detail below. Embodiments within the scope of the present invention also include computer-readable media for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system.

In this description and in the following claims, a “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data.

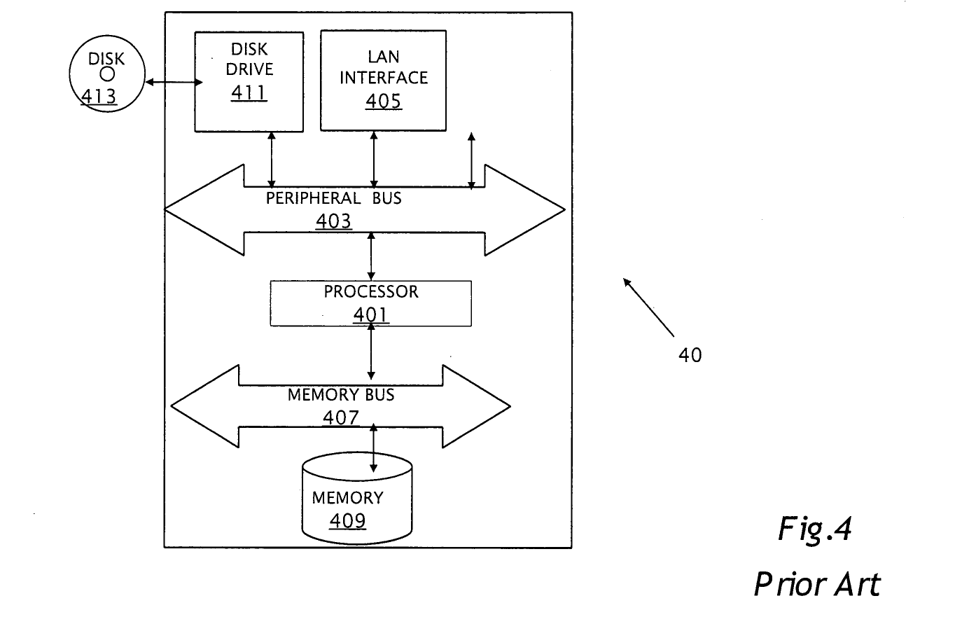

Reference is now made to FIG. 4 which illustrates schematically a simplified computer system 40. Computer system 40 includes a processor 401, a storage mechanism including a memory bus 407 to store information in memory 409 and a network interface 405 operatively connected to processor 401 with a peripheral bus 403. Computer system 40 further includes a data input mechanism 411, e.g. disk drive for a computer readable medium 413, e.g. optical disk. Data input mechanism 411 is operatively connected to processor 401 with peripheral bus 403.

Those skilled in the art will appreciate that the invention may be practiced with many types of computer system configurations, including mobile telephones, PDA's, pagers, hand-held devices, laptop computers, personal computers, multi-processor systems, microprocessor-based or programmable consumer electronics, network PCs, minicomputers, mainframe computers, and the like. The invention may also be practiced in distributed computing environments where local and remote computer systems, which are linked (either by hardwired links, wireless links, or by a combination of hardwired or wireless links) through a communication network, both perform tasks. In a distributed computing environment, program modules may be located in both local and remote memory storage devices.

By way of introduction, a principal intention of the present invention is to provide a method for improving performance of a speech recognition engine by distributing the vocabulary used by the engine into multiple orthogonal dictionaries and subsequently processing an input audio signal in parallel using multiple instances of the speech recognition engine, each instance using one of the multiple dictionaries. Each dictionary preferably includes an equal number of words, i.e. the vocabulary is preferably distributed substantially equally among the dictionaries. The distribution of the vocabulary into orthogonal dictionaries improves speech recognition performance because each channel uses a smaller dictionary, thereby increasing the confidence level of the speech recognition. Furthermore, since the words in each channel have been selected, according to an embodiment of the present invention for orthogonality, that is to have a large phonetic distance from each other, an even higher confidence level may be achieved or in a different design a faster or simpler speech recognition algorithm may be used for the channels than would be required without distributing orthogonally into separate dictionaries according to the teachings of the present invention.

Many speech recognition algorithms are known. One class of commonly used algorithms are based on hidden Markov models (HMM). The speech recognition algorithm for use with embodiments of the present invention may be of any such mechanisms known in the art.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

### A. Calculation of Phonetic Distance Between Phonemes and Words

According to different embodiments of the present invention the speech recognition vocabulary is distributed into orthogonal dictionaries using one or more of the following techniques. For each pair of words selected from each of the dictionaries a relative long phonetic distance is achieved between the words of the dictionary:

1) based on respective formants of corresponding vowel sounds of the two words. The formants f1 and f2 are typically in a known frequency range in Hertz of, relative frequencies, e.g. ratio of f2/f1 and/or relative amplitudes of f1 and f2.

2) based on the anatomical part, e.g. lips, teeth, tongue, palate, throat, most responsible for forming the sound made by the letter. For example, in English sounds, from letters b, f, p, v and w are formed in the lips; sounds from letters l, j, r, sh, z, d, l, n, t are formed by the tip of the tongue and/or the front palate; sounds from letters g, k and y are produced by the base of the tongue on the rear palate; and sounds formed in the throat are from letters a, e, h, i, and o.

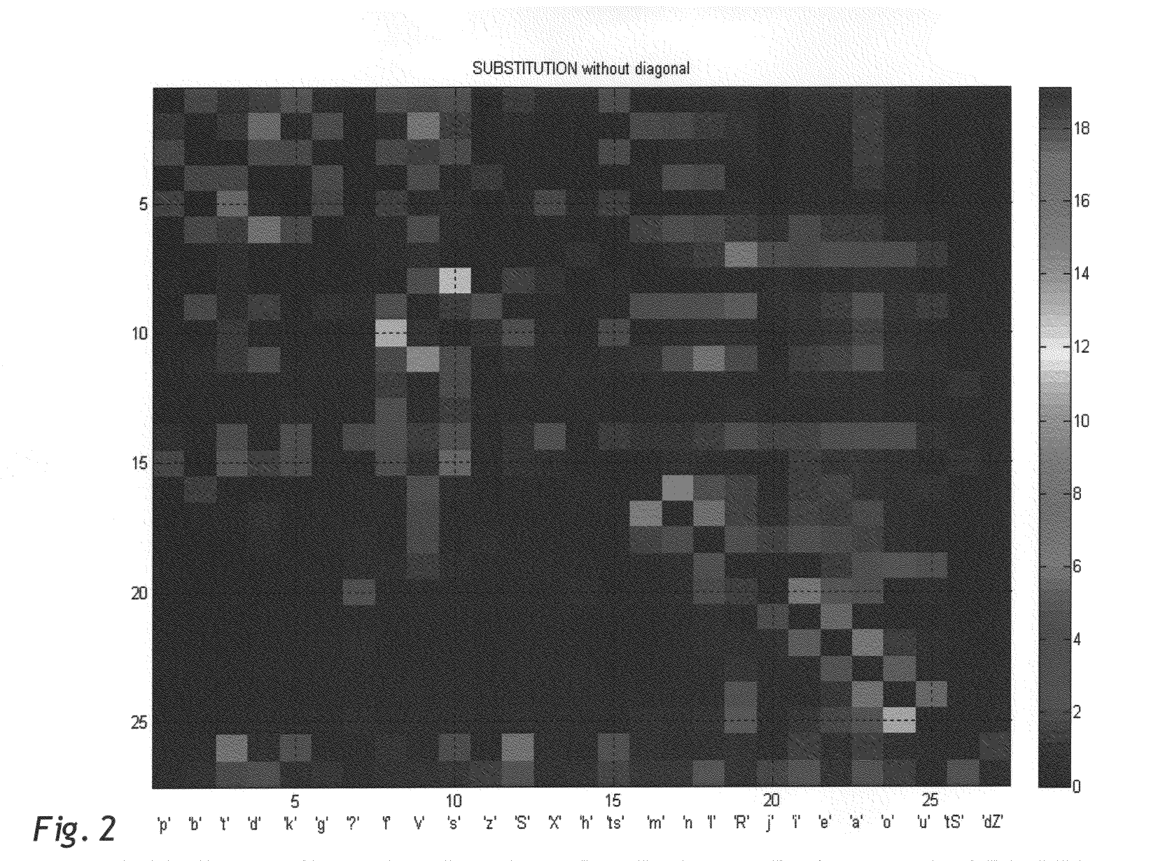

3) based on empirical results of a speech recognition engine. In speech recognition there are three types of errors: insertion error, substitution error and deletion error. An insertion error occurs when the speech recognition engines inserts a syllable or word when a corresponding syllable or word was not in the audio signal. A substitution error occurs when the speech recognition engine substitutes a syllable or word when a corresponding syllable or word was not in the audio signal. A deletion error occurs when the speech recognition engine deletes a corresponding syllable or word. Reference is now made to FIG. 2 which illustrates a substitution matrix for phonemes in the Hebrew language. Both the vertical and horizontal axis are the phonemes in the order as shown. The horizontal axis x indicates the phoneme input to the speech recognition engine and the vertical axis y (with numbering starting at the top and increasing downwords) indicates a particular phoneme recognized. The color at square {x,y} indicates the likelihood of recognizing the phoneme numbered on the y axis after inputting the phoneme numbered at the x axis. A key (0-18%) appears on the right which indicates a probability of a speech recognition engine to substitute one sound (at x) for another (at y). As an example, when the phoneme ‘t’ at the x=3 position is input there is a relatively high probability ˜16% to be substituted in error for a ‘ts’ phoneme at the y=15 position. Other phonemes with a probability of substitution error, above ˜10% include: {‘u’, ‘o’}, {‘t’, ‘p’}, {‘s’, ‘z’} {‘f’, ‘v’}, {‘f’, ‘s’}, {‘n’, ‘m’} Similar matrices may be constructed for insertion and deletion errors for different pairs of input sounds.

4) based on Levinstein distance. The Levinstein distance is used, according to an embodiment of the present invention, to calculate a phonetic distance between words, for instance when a phonetic distance between phonemes of the words is determined from a substitution matrix (FIG. 2) and/or from probabilities of insertion and/or deletion of phonemes based on empirical results from the speech recognition engine.

### B. Distribution of Vocabulary into Multiple Dictionaries

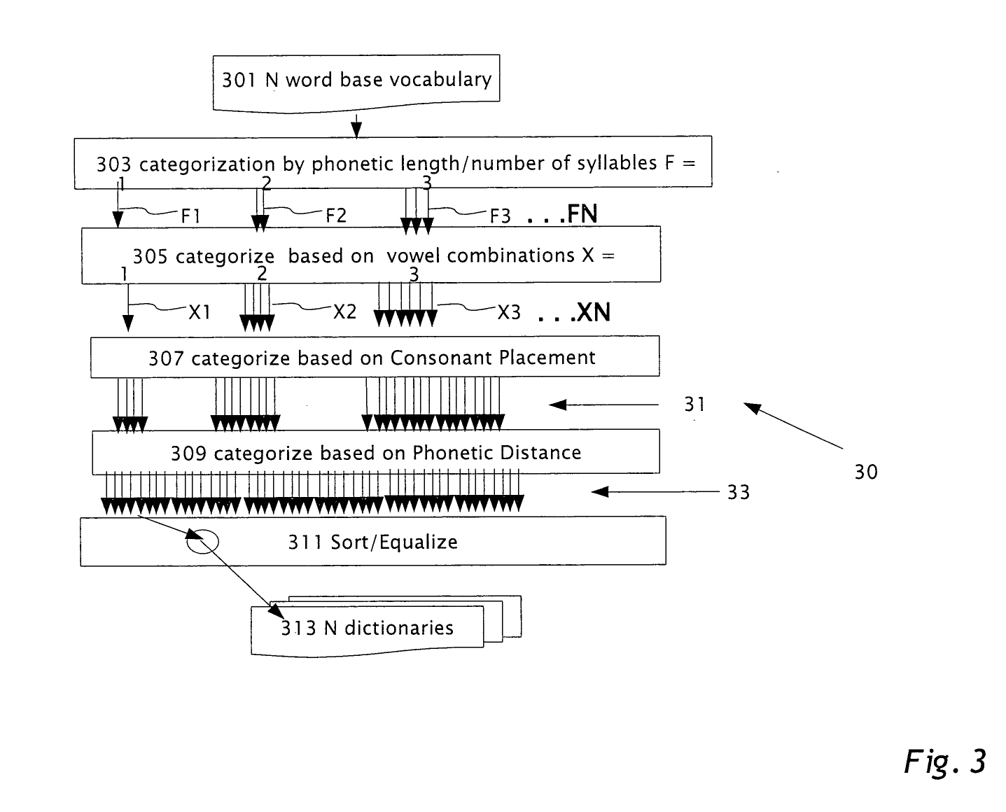

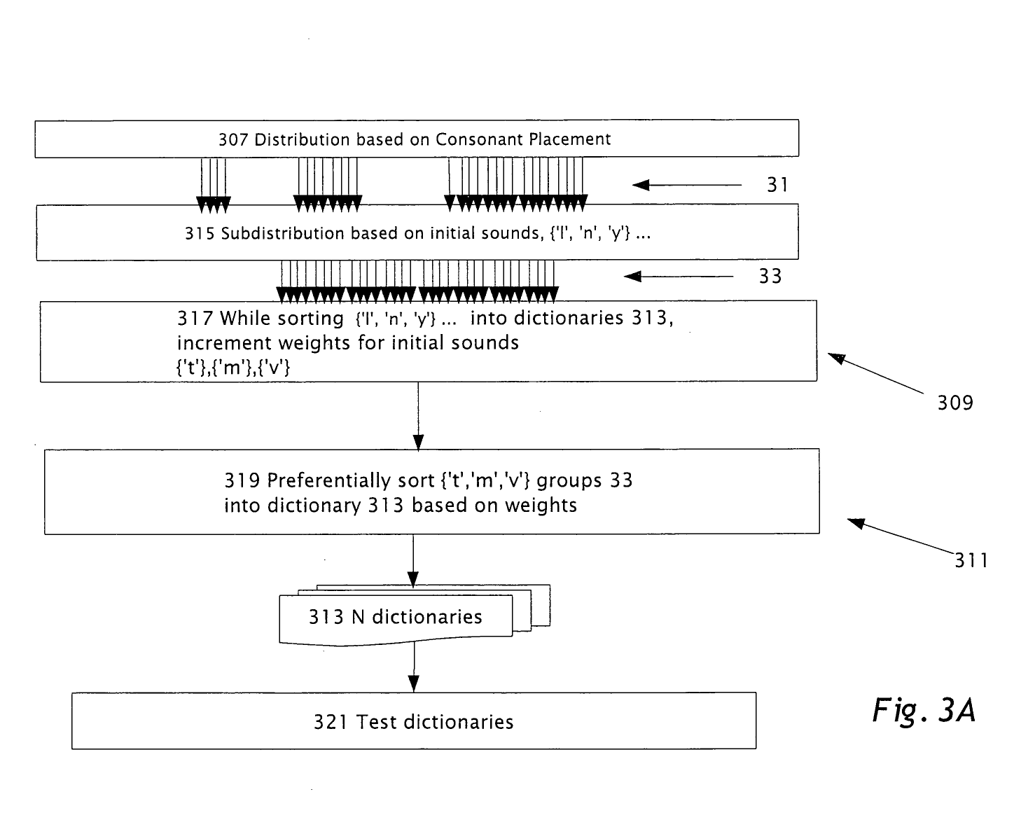

The first criterion for the construction of orthogonal dictionaries, according to an embodiment of the present invention, is to maximize the phonetic distance between all the pairs of words of the dictionary. Another preferable criterion is “balance” or distributing the number of words in the vocabulary substantially equally among the channels. Reference is now made to FIG. 3 which illustrates schematically a method 30 for distributing a target vocabulary 301 into multiple orthogonal dictionaries. In order to distribute target vocabulary 301 into multiple orthogonal dictionaries, vocabulary are first categorized into groups of minimal phonetic distance between the members of each group, the categorization is performed, according to different embodiments of the present invention by applying the following steps, preferably in the order presented:

### 303 Categorization by Phonetic Length

Step 303 includes categorization of target vocabulary 301 according the number of syllables in each word or phonetic length, or based on the number of vowel sounds in each word of target vocabulary 301. The output of categorization (step 303) is shown in method 30 with F1, F2, F3 . . . Fn which the integer following the F symbol indicates the number of vowel sounds, or syllables in the word. In Hebrew, there are twelve vowel sounds:
{‘a’,‘i’,‘o’,‘e’,‘u’, ‘ai’,‘oi’,‘ei’,‘ui’,‘au’,‘ou’,‘eu’}

Monosyllabic words, denoted as F1 include words with a consonant (consonant denoted with an asterisk *) after the vowel, such as a* with a vowel followed by a consonant, *a or with both a leading and a trailing consonant *a*. The Hebrew language unlike the English language does not have any words with a single vowel without at least one consonant. Monosyllabic words F1 are categorized into 12 lists, one list for each vowel spoken in the Hebrew language. Examples of Hebrew words in transliteration in the group F1 including monosyllabic words EL and AL. Disyllabic words F2 include combinations of two vowel sounds, generally separated by an intervening consonant. For example, in transliteration words such as: “A-TEN”, “LE-XI, “DVA-RIM” are disyllabic F2 words. The hyphen “-” is used to show the separation between the two syllables, The X is used in transliterated words represents the voiceless velar fricative ‘X’. Accordingly, trisyllabic F3, tetrasyllabic F4 and pentasyllabic F5 words are categorized (step 301) according to phonetic length. Words in transliteration from Hebrew in different F3 groups include” “DA-A-GA”, “BE-NEI-NU”.

### 305 Categorization by Vowel Combinations

Each of the groups of F2, F3 , , , FN are preferably further categorized by vowel combinations denoted X2, X3 . . . XN. For twelve vowels, there are 12×12 or 144 lists of words in X2 and 12³ or 1728 vowel combinations in X3. An Israeli Airline is “EL-AL” a word in group X2, “E-A”. Other examples of vowel combinations F2 include “E-E” as in the Hebrew word transliterated LEXEM for the Hebrew word for “bread”; “E-I” as in the Hebrew word transliterated “LEXI”. Words in transliteration from Hebrew both in the same group X4 “I-A-E-U” include “HISH-TAX-RE-RU” and “HIT-AR-E-RU”.

### 307 Categorization by Consonant Placement

Each of the groups of X1, X2, X3 . . . XN are preferably further sub-categorized according to consonant combinations into smaller groups or subcategories 31. Consonants in the Hebrew language include:
{‘b’,‘g’,‘d’,‘h’,‘v’,‘z’,‘x’,‘t’,‘y’,‘k’,‘l’,‘m’,‘n’,‘s’,‘ts’,‘tS’,‘dj’, ‘S’, ‘p’,‘f’,‘r’}
   As an example of step 307, the group X2 with vowel order “E-E” is further subcategorized into subcategories 31 based on the placement of consonants around the two vowels of “E-E”. One sub-group 31 includes E*E*. (Asterisk * is in place of a consonant) Examples of E*E* words include in transliteration: EL-EX, E-TSEL, E-GED and examples of words in a different subcategory 31 *E*E, include in transliteration DE-REX, DE-LET, BE-GED.

### 309 Group by Phonetic Distance

According to embodiments of the present invention, each sub-group 31 is further analyzed to determine phonetic distance between any two words within each sub-group 31. Words within each sub-group 31 which are close phonetically, i.e. have a short phonetic distance between them are placed in the same sub-group 33. Phonetic distance between any two words within each sub-group 31 may be determined by any such techniques known in the art or by any of the techniques described in section A above, singly or in combination: (1) based on respective formants (2) based on based on the anatomical part, e.g. lips, teeth, tongue, palate, throat, most responsible for forming the sound made by the letter, (3) based on empirical results of a speech recognition engine. For instance, letters with sounds that are frequently confused ‘u’, ‘o’ are placed in same group 33 and/or 4) based on Levinstein distance between the words.

As an example, Hebrew words in transliteration {NA-A-VOR, YA-A-VOR, LA-A-VOR} are trisyllabic (F3) words, belonging to the same X3 group with vowel sounds “A-A-O” and belonging to the same group 31, “*A-A-*O*”. (Again * denotes a consonant) Given that the second consonant “V” and third consonant “R” (and corresponding consonant sounds) are identical in each of the three words, and the first consonants are in a group, {‘l’, ‘y’, ‘n’} which include sounds which are easily confused, known from anatomical part as pronounced in Hebrew (section A(2) above) and/or from empirical results (section A(3) above), the words {NA-A-VOR, YA-A-VOR, LA-A-VOR} are placed in a single sub-group 33. Taking the words of each group 33 as pairs, there is a minimal phonetic distance between the words. Hence the words of each group 33 are easily recognized incorrectly or confused by a speech recognition engine.

According to an embodiment of the present invention, the first sound of each of the words in groups 31 is selected and used to subdistribute each group 31 into even smaller groups 33 based for instance on the following eight letter groupings. LNY, FSRXK, BGD, TMV, the remaining consonants and the vowels. As discussed above, sounds {‘l’, ‘n’, ‘y’} are relatively easily confused, as are sounds {‘f’, ‘s’, ‘R’, ‘X’, ‘k’}, and sounds {‘b’, ‘g’, ‘d’}.

Each group 33 containing a small number (e.g. 3 words) are sorted (step 311) into dictionaries 313. Typically sorting (step 311) is performed in the order from smaller words (e.g. one syllable) to larger words so that similar words, (with minimal phonetic distance between them) in each group 33 are sorted into different dictionaries. Sorting (step 311) into dictionaries 313 is preferably performed so that the smallest dictionary during sorting 311 is incremented with another word, (if all other constraints are equal).

Reference is now made to FIG. 3A, a flow diagram according to an embodiment of the present invention. Groups 33 are subdistributed (step 315) are based (as above in method 30) on the eight letter groupings: LNY, FSRXK, BGD, TMV, the remaining consonants and the vowels. During sorting (step 311) groups 33 are selected first with sounds {‘l’, ‘n’, ‘y’}, {‘f’, ‘s’, ‘R’, ‘X’, ‘k’}, {‘b’, ‘g’, ‘d’}, the remaining consonants and the vowels, leaving initial sounds {‘t’}, {‘m’}, {‘v’} for processing last. While sorting (step 311) weights are incremented (step 317) for dictionaries 313 based on whether the {‘t’}, {‘m’}, or {‘v’} sounds appear in the word being sorted into each dictionary 313 and if so the weight, Wₜ, Wₘ and/or Wᵥ is increased by 1 for each dictionary 313. Otherwise if the {‘t’}, {‘m’} or {‘v’} sound does not appear in the word being sorted the weights Wₜ, Wₘ and/or Wᵥ per dictionary 313 are not incremented. Subsequently when groups 33 with initial sounds {‘t’}), {‘m’}, {‘v’} are sorted into dictionaries 313, the calculated weights may be used as a basis for selecting into which dictionary 313 to sort the words with initial sounds {‘t’}, {‘m’}, {‘v’}, the higher the weight, the more problematic the choice of dictionary 313. If weights are substantially identical for adding a word into two dictionaries 313 then dictionary 313 of smaller number of words is selected for the word being sorted (step 311)

After sorting (step 311), the dictionaries are preferably tested (step 321) for potential similarities between any two words. Examples of words, in Hebrew transliteration which may fall into the same dictionary are BANIM and ANI, or KIBALT and KIBALT. One method for testing includes calculating Levinstein distances between all the words within each dictionary 313.

Attached is an Appendix including a table in 24 pages. The columns are numbered from 1-8, include respectively 8 dictionaries 313 generated from target vocabulary 301 using method 30. Target vocabulary 301 includes 3352 words in Hebrew transliteration distributed into 8 dictionaries of 419 words each in Hebrew transliteration.

While the invention has been described with respect to a limited number of embodiments, it will be appreciated that many variations, modifications and other applications of the invention may be made.

What is claimed is:

1. A computerized method for distribution among a plurality of dictionaries of a target vocabulary including a plurality of words for use in a speech recognition application installed in a computer system, wherein each word of said target vocabulary is found in only one of the dictionaries, wherein the vocabulary and the dictionaries are stored in memory operatively attached to a computer system, the method comprising the steps of:
(a) first categorizing the words based on phonetic length, thereby distributing the words into a plurality of first groups each of equal phonetic length
(b) second categorizing said first groups based on combinations of vowel sounds, thereby placing the words of said first groups into a plurality of second groups each of identical vowel sounds;
(c) third categorizing the words of said second groups based on the consonants of the words of said second groups and placement of said consonants relative to said vowel sounds, thereby distributing the words into a plurality of third groups,
(c) comparing pairwise phonetic distance between the words within each of said third groups thereby placing the words of said third groups into fourth groups of minimal phonetic distance; and
(d) distributing the words of said fourth groups into the multiple dictionaries.

2. The method of claim 1, wherein the multiple dictionaries are mutually orthogonal, whereby each of the dictionaries includes words of maximal phonetic distance from each other.

3. The method of claim 1, wherein said pairwise comparing is performed by at least one of the steps consisting of: (i) comparing pairwise formants of the vowel sounds of the words, (ii) comparing an anatomical part most responsible for forming respective sounds; (iii) comparing empirically incorrect substitution of the words using a speech recognition engine, and (iv) calculating Levinstein distance between the words.

4. The method of claim 1, wherein said distributing is performed under the constraint of substantially balancing the respective number of words in the dictionaries.

5. The method of claim 1, further providing the step of:
(e) while performing said distributing, calculating weights for the words not yet distributed, whereby said weights are a measure of phonetic distance for the words not yet distributed to the words already distributed into the dictionaries and continuing said distributing based on said weights.

6. A computerized method for distribution among a plurality of dictionaries of a target vocabulary including a plurality of words for use in a speech recognition application installed in a computer system, wherein each word of said target vocabulary is found in only one of the dictionaries, wherein the vocabulary and the dictionaries are stored in memory operatively attached to a computer system, the method comprising the steps of:
(a) comparing pairwise phonetic distance between the words thereby placing the words of into groups of minimal phonetic distance; wherein said pairwise comparing is performed by at least one of the steps consisting of: (i) comparing pairwise formants of the vowel sounds of the words, (ii) comparing an anatomical part most responsible for forming respective sounds; and (iii) comparing empirically substitution of the words using a speech recognition engine;
(b) distributing the words of said groups into the multiple dictionaries; and
(c) processing an audio signal using multiple speech recognition engines, each engine referring to one of the dictionaries.

7. The method of claim 6, wherein the multiple dictionaries are mutually orthogonal, whereby each of the dictionaries includes words of maximal phonetic distance from each other.

8. The method of claim 6, wherein said distributing is performed under the constraint of substantially balancing the respective number of words in the dictionaries.

9. The method of claim 6, further providing the step of:
(e) while performing said distributing calculating weights for the words not yet distributed, whereby said weights are a measure of phonetic distance for the words not yet distributed to the words already distributed into the dictionaries and continuing said distributing based on said weights.

10. The method of claim 6, further comprising the step of, prior to said comparing:
(d) first categorizing the words based on phonetic length, thereby distributing the words into a plurality of first groups each of equal phonetic length.

11. The method, according to claim 10, further comprising the step of:
(e) second categorizing said first groups based on combinations of vowel sounds, thereby placing the words of said first groups into a plurality of second groups each of identical vowel sounds;

12. The method, according to claim 11, further comprising the step of:
(f) third categorizing the words of said second groups based on the consonants of the words of said second groups and placement of said consonants relative to said vowel sounds, thereby distributing the words into a plurality said groups.

13. A computer readable medium readable by a machine, tangibly embodying a program of instructions executable by the machine to perform a computerized method for distribution among a plurality of dictionaries of a target vocabulary including a plurality of words for use in a speech recognition application installed in a computer system, wherein each word of said target vocabulary is found in only one of the dictionaries, the method comprising the steps of:
(a) first categorizing the words based on phonetic length, thereby distributing the words into a plurality of first groups each of equal phonetic length
(b) second categorizing said first groups based on combinations of vowel sounds, thereby placing the words of said first groups into a plurality of second groups each of identical vowel sounds;
(c) third categorizing the words of said second groups based on the consonants of the words of said second groups and placement of said consonants relative to said vowel sounds, thereby distributing the words into a plurality of third groups,
(c) comparing pairwise phonetic distance between the words within each of said third groups thereby placing the words of said third groups into fourth groups of minimal phonetic distance; and
(d) distributing the words of said fourth groups into the multiple dictionaries.

14. A computer readable medium readable by a machine, tangibly storing the multiple dictionaries produced by the method steps of claim 1.
